(19) United States
(12) Patent Application Publication
(10) Pub. No.: US 2022/0138346 A1
(43) Pub. Date: May 5, 2022

(54) SYSTEMS AND METHODS FOR ADAPTIVE ELECTRONIC PRIVACY SCREEN BASED ON INFORMATION HANDLING SYSTEM CONTEXT

(71) Applicant: Dell Products L.P., Round Rock, TX (US)

(72) Inventors: Vivek Viswanathan IYER, Austin, TX (US); Daniel L. HAMLIN, Round Rock, TX (US)

(73) Assignee: Dell Products L.P., Round Rock, TX (US)

(21) Appl. No.: 17/087,242

(22) Filed: Nov. 2, 2020

(51) Int. Cl. G06F 21/62; G06F 21/55

(52) U.S. Cl. CPC G06F 21/6245; G06F 21/554

(57) ABSTRACT

A method may include executing a privileged service on top of an operating system of an information handling system, the privileged service configured to: (i) configure a rules engine defining rules for selectively enabling and disabling an electronic privacy screen of a display device associated with the information handling system, the rules based on a configuration policy; (ii) in response to an event for triggering enabling or disabling of the electronic privacy screen, determine a context of the information handling system; (iii) based on the context and the rules engine, determine whether a threat level associated with the event is within a range for enabling the electronic privacy screen; and (iv) based on the threat level, cause communication of a control signal to the display device, the control signal indicative of whether to enable or disable the electronic privacy screen.

### TECHNICAL FIELD

The present disclosure relates in general to information handling systems, and more particularly to methods and systems for providing an adaptive electronic privacy screen based on an information handling system context.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a user of an information handling system opens a privileged or confidential electronic document, it may be desirable to prevent persons other than the user from viewing the electronic document on a display device to which the electronic document is displayed. Accordingly, some traditional display devices are equipped with privacy screens that minimize a brightness and/or minimize a viewing angle at which a display screen may be viewed, in order to restrict viewing of the display screen by persons other than the user. More recently, display devices have become equipped with electronic privacy screens, which include a selectable optical filter which allows a user to select whether to enable such optical filter to minimize brightness and/or viewing angle, or to disable such optical filter, allowing “normal” brightness and/or viewing angle. However, such manual selectivity by a user may be prone to user error, as a user may fail to selectively enable the optical filter when opening privileged or confidential electronic documents.

### SUMMARY

In accordance with the teachings of the present disclosure, the disadvantages and problems associated with privacy of electronic documents may be reduced or eliminated.

In accordance with embodiments of the present disclosure, an information handling system may include a processor and a privileged service embodied in a program of instructions stored on computer-readable media accessible to the processor and configured to, when read and executed by the processor on top of an operating system of the information handling system: (i) configure a rules engine defining rules for selectively enabling and disabling an electronic privacy screen of a display device associated with the information handling system, the rules based on a configuration policy; (ii) in response to an event for triggering enabling or disabling of the electronic privacy screen, determine a context of the information handling system; (iii) based on the context and the rules engine, determine whether a threat level associated with the event is within a range for enabling the electronic privacy screen; and (iv) based on the threat level, cause communication of a control signal to the display device, the control signal indicative of whether to enable or disable the electronic privacy screen.

In accordance with these and other embodiments of the present disclosure, a method may include executing a privileged service on top of an operating system of an information handling system, the privileged service configured to: (i) configure a rules engine defining rules for selectively enabling and disabling an electronic privacy screen of a display device associated with the information handling system, the rules based on a configuration policy; (ii) in response to an event for triggering enabling or disabling of the electronic privacy screen, determine a context of the information handling system; (iii) based on the context and the rules engine, determine whether a threat level associated with the event is within a range for enabling the electronic privacy screen; and (iv) based on the threat level, cause communication of a control signal to the display device, the control signal indicative of whether to enable or disable the electronic privacy screen.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to execute a privileged service on top of an operating system of an information handling system, the privileged service configured to: (i) configure a rules engine defining rules for selectively enabling and disabling an electronic privacy screen of a display device associated with the information handling system, the rules based on a configuration policy; (ii) in response to an event for triggering enabling or disabling of the electronic privacy screen, determine a context of the information handling system; (iii) based on the context and the rules engine, determine whether a threat level associated with the event is within a range for enabling the electronic privacy screen; and (iv) based on the threat level, cause communication of a control signal to the display device, the control signal indicative of whether to enable or disable the electronic privacy screen.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system comprising an information handling system and a display device, in accordance with embodiments of the present disclosure; and

FIG. 2 illustrates a flow chart of an example method for controlling an adaptive electronic privacy screen based on information handling system context, in accordance with embodiments of the present disclosure.

### DETAILED DESCRIPTION

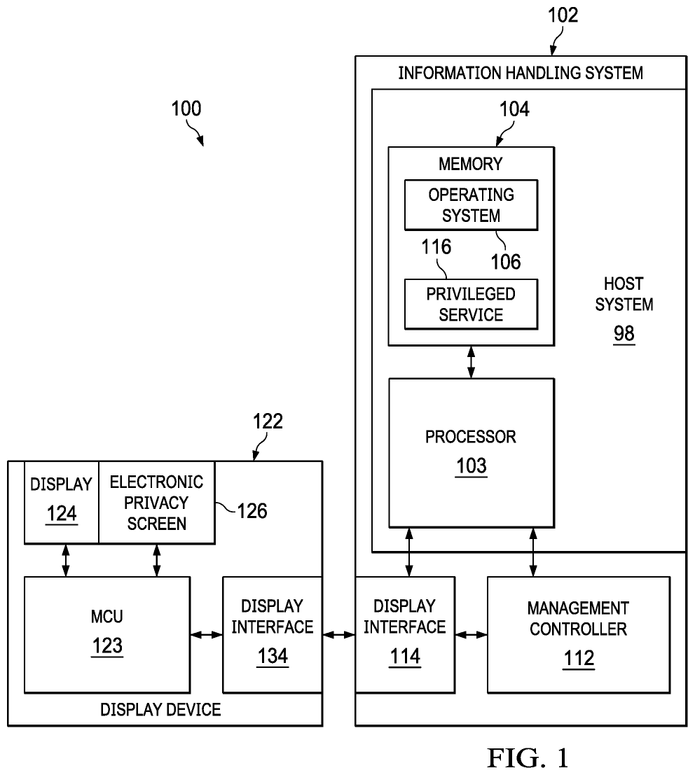

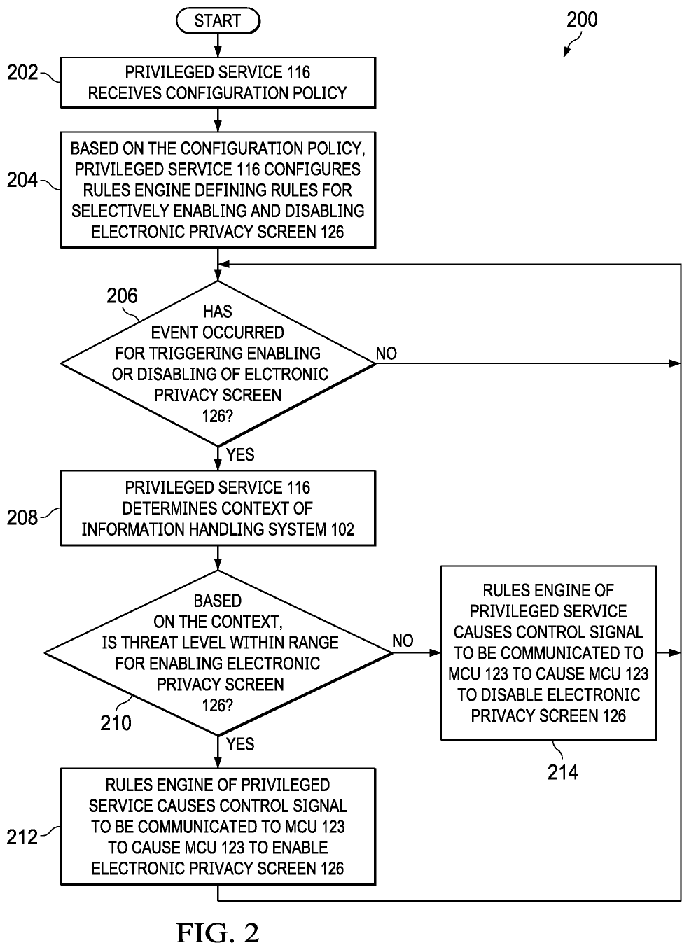

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 comprising an information handling system 102 and a display device 122, in accordance with embodiments of the present disclosure. Although FIG. 1 depicts display device 122 as externally coupled to information handling system 102 (e.g., via an appropriate external cable) in some embodiments (e.g., a notebook or tablet), display device 122 may be integrated with information handling system 102 into a common chassis and/or enclosure.

In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, and a display interface 114 communicatively coupled to processor 103 and management controller 112. In operation, processor 103 and memory 104 may comprise at least a portion of a host system 98 of information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. As shown in FIG. 1, memory 104 may have stored thereon an operating system 106 and a privileged service 116.

Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Privileged service 116 may comprise an application embodied by a program of instructions, that when loaded and executed by processor 103, executes in a privileged context on top of operating system 106 in order to perform the functionality of privileged service 116. In operation, as described in more detail below, privileged service 116 may, based on a context of information handling system 102, determine whether a threat level exists for enabling an electronic privacy screen of display device 122, and if such threat level exists, cause the electronic privacy screen of display device 122 to be enabled.

Management controller 112 may be configured to provide management facilities for management of information handling system 102. Such management may be made by management controller 112 even if information handling system 102 is powered off or powered to a standby state. Management controller 112 may include a processor, a memory, and or other components, such as display interface 114. In certain embodiments, management controller 112 may include or may be an integral part of an embedded controller (EC), baseboard management controller (BMC), or a remote access controller (e.g., a Dell Remote Access Controller or Integrated Dell Remote Access Controller).

Display interface 114 may comprise any suitable system, device, or apparatus configured to serve as a communication interface between display device 122 and either or both of processor 103 and management controller on 112. For example, in some embodiments, display interface 114 may comprise a cable interface in accordance with the Universal Serial Bus Power Delivery (USB PD) specification. In these and other embodiments, display interface 114 may be communicatively coupled to management controller 112 via an Inter-Integrated Circuit (I2C) communications bus.

In addition to processor 103, memory 104, management controller 112, and display interface 114, information handling system 102 may include one or more other information handling resources. In addition, although FIG. 1 shows information handling system 102 configured as what many would consider a computing system, in some embodiments, information handling system 102 may include fewer components than that often seen in a computing system, and may comprise a device with less functionality, such as a docking station or port replicator.

As depicted in FIG. 1, display device 122 may include a microcontroller unit (MCU) 123, a display 124 communicatively coupled to MCU 123, a display interface 134 communicatively coupled to MCU 123, and an electronic privacy screen 126 communicatively coupled to MCU 123 and optically coupled to display 124.

MCU 123 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, MCU 123 may implement a privacy mode configuration engine that may be configured to, based on a control signal communicated from information handling system 102, selectively enable and disable electronic privacy screen 126 of display device 122 as described in greater detail below.

Display 124 may include any system, device, or apparatus configured to generate graphical images and/or reproduce alphanumeric text for viewing by a user of information handling system 102, based on display data communicated to display 124 from information handling system 102. Display 124 may comprise a light-emitting diode display, liquid crystal display, and/or any other suitable display.

Display interface 134 may comprise any suitable system, device, or apparatus configured to serve as a communication interface between display device 122 and either or both of processor 103 and management controller 112. For example, in some embodiments, display interface 134 may comprise a cable interface in accordance with the USB PD specification.

For clarity of exposition, FIG. 1 depicts only a single display device 122 communicatively coupled to information handling system 102. However, in some embodiments of system 100, system 100 may include a plurality of display devices 122 communicatively coupled to information handling system 102 (e.g., directly to information handling system 102 or in a daisy chain from display device 122 to display device 122).

Also, for clarity of exposition, FIG. 1 depicts display device 122 directly coupled to information handling system 102. However, in some embodiments of system 100, system 100 may include a docking station or port replicator communicatively coupled between information handling system 102 and display device 122.

In operation, privileged service 116 may configure a rules engine for selectively enabling and disabling electronic privacy screen 126. Such rules engine may be based on a configuration policy for information handling system 102, wherein such configuration policy may be set by a user or administrator of information handling system 102. Further, in response to an event (e.g., change in electronic document content to be displayed, change in information protection setting for an already-open document, etc.), privileged service 116 may determine a context of information handling system 102 (e.g., location, device state, etc.) and apply the rules engine to the context to determine a threat level. If the threat level is within a range for enabling electronic privacy screen 126, privileged service 116 may cause MCU 123 to enable electronic privacy screen 126 (e.g., by causing communication of an appropriate control signal via display interface 114). Likewise, if the threat level is outside the range for enabling electronic privacy screen 126, privileged service 116 may cause MCU 123 to disable electronic privacy screen 126.

FIG. 2 illustrates a flow chart of an example method 200 for controlling an adaptive electronic privacy screen based on information handling system context, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, privileged service 116 may receive a configuration policy. Such configuration policy may be set by a user or administrator of information handling system 102. In some embodiments, such configuration engine may be received from a back-end Integrated Technology and Device Manufacturer (ITDM) interface which defines threat-level rules, content to monitor, and/or other parameters.

At step 204, based on the configuration policy, privileged service 116 may configure a rules engine defining rules for selectively enabling and disabling electronic privacy screen 126.

At step 206, privileged service 116 may determine whether an event has occurred that may trigger enabling or disabling electronic privacy screen 126. Such event may be defined by rules within the rules engine, and may include the opening of a new electronic document on information handling system 102, closing of an open electronic document on information handling system 102, changing an information protection setting for an already-open electronic document on information handling system 102, and/or another suitable event. If an event occurs, method 200 may proceed to step 208. Otherwise, method 200 may remain at step 206 until an event occurs.

At step 208, in response to an event, privileged service 116 may determine a context of information handling system 102. Context of information handling system 102 may include any operating parameters associated with information handling system 102, including without limitation its physical location, device state (e.g., hinge angle, posture, battery/power state, security posture, input/output context, ambient lighting, color temperature), application context, sensor information (e.g., gyroscope, acceleration), and/or other suitable parameters.

At step 210, based on the context, the rules engine may determine a threat level associated with the event. If the threat level is within a range for enabling electronic privacy screen 126, method 200 may proceed to step 212. If the threat level is outside the range for enabling electronic privacy screen 126, method 200 may proceed to step 214.

At step 212, the rules engine of privileged service 116 may cause a control signal to be communicated to MCU 123 to cause MCU 123 to enable electronic privacy screen 126. In embodiments in which display device 122 is external to but directly coupled to information handling system 102, and in embodiments in which display device 122 is integrated within a common enclosure with information handling system 102, causing the control signal to be communicated to MCU 123 may include communication by processor 103 or management controller 112 of the control signal via display interfaces 114 and 134 to MCU 123. In embodiments in which a docking station or other equipment is interfaced between display device 122 and information handling system 102, privileged service 116 may cause the control signal to be communicated to such intermediate device, and the intermediate device may in turn communicate the same or a similar control signal to MCU 123. After completion of step 212, method 200 may proceed again to step 206.

At step 214, the rules engine of privileged service 116 may cause a control signal to be communicated to MCU 123 to cause MCU 123 to disable electronic privacy screen 126. In embodiments in which display device 122 is external to but directly coupled to information handling system 102, and in embodiments in which display device 122 is integrated within a common enclosure with information handling system 102, causing the control signal to be communicated to MCU 123 may include communication by processor 103 or management controller 112 of the control signal via display interfaces 114 and 134 to MCU 123. In embodiments in which a docking station or other equipment is interfaced between display device 122 and information handling system 102, privileged service 116 may cause the control signal to be communicated to such intermediate device, and the intermediate device may in turn communicate the same or a similar control signal to MCU 123. After completion of step 214, method 200 may proceed again to step 206.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using display device 122, MCU 123, and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a privileged service embodied in a program of instructions stored on computer-readable media accessible to the processor and configured to, when read and executed by the processor on top of an operating system of the information handling system:
configure a rules engine defining rules for selectively enabling and disabling an electronic privacy screen of a display device associated with the information handling system, the rules based on a configuration policy;
in response to an event for triggering enabling or disabling of the electronic privacy screen, determine a context of the information handling system;
based on the context and the rules engine, determine whether a threat level associated with the event is within a range for enabling the electronic privacy screen; and
based on the threat level, cause communication of a control signal to the display device, the control signal indicative of whether to enable or disable the electronic privacy screen.

2. The information handling system of claim 1, wherein the event comprises one of an opening of an electronic document, a closing of an electronic document, and a change in an information protection setting of an electronic document.

3. The information handling system of claim 1, wherein the context comprises one or more of a physical location of the information handling system, a device state of the information handling system, sensor data associated with the information handling system, and an application context of the information handling system.

4. The information handling system of claim 1, wherein the display device is integrated with the information handling system in a common enclosure, and causing communication of the control signal to the display device comprises communication of the control signal through a communications interface coupled between the processor and a microcontroller unit of the display device.

5. The information handling system of claim 1, wherein the display device is externally coupled to the information handling system via a cable, and causing communication of the control signal to the display device comprises communication of the control signal through a communications interface coupled between the information handling system and the display device.

6. The information handling system of claim 1, wherein the display device is externally coupled to the information handling system via an intermediate device, and causing communication of the control signal to the display device comprises communication of the control signal from the information handling system to the intermediate device, and communication of the control signal from the intermediate device to the display device.

7. The information handling system of claim 1, wherein causing communication of the control signal to the display device comprises communication of the control signal from a management controller of the information handling system.

8. A method comprising executing a privileged service on top of an operating system of an information handling system, the privileged service configured to:
configure a rules engine defining rules for selectively enabling and disabling an electronic privacy screen of a display device associated with the information handling system, the rules based on a configuration policy;
in response to an event for triggering enabling or disabling of the electronic privacy screen, determine a context of the information handling system;
based on the context and the rules engine, determine whether a threat level associated with the event is within a range for enabling the electronic privacy screen; and
based on the threat level, cause communication of a control signal to the display device, the control signal indicative of whether to enable or disable the electronic privacy screen.

9. The method of claim 8, wherein the event comprises one of an opening of an electronic document, a closing of an electronic document, and a change in an information protection setting of an electronic document.

10. The method of claim 8, wherein the context comprises one or more of a physical location of the information handling system, a device state of the information handling system, sensor data associated with the information handling system, and an application context of the information handling system.

11. The method of claim 8, wherein the display device is integrated with the information handling system in a common enclosure, and causing communication of the control signal to the display device comprises communication of the control signal through a communications interface coupled between the processor and a microcontroller unit of the display device.

12. The method of claim 8, wherein the display device is externally coupled to the information handling system via a cable, and causing communication of the control signal to the display device comprises communication of the control signal through a communications interface coupled between the information handling system and the display device.

13. The method of claim 8, wherein the display device is externally coupled to the information handling system via an intermediate device, and causing communication of the control signal to the display device comprises communication of the control signal from the information handling system to the intermediate device, and communication of the control signal from the intermediate device to the display device.

14. The method of claim 8, wherein causing communication of the control signal to the display device comprises communication of the control signal from a management controller of the information handling system.

15. An article of manufacture comprising:
a non-transitory computer-readable medium; and
computer-executable instructions carried on the computer-readable medium, the instructions readable by a processor, the instructions, when read and executed, for causing the processor to execute a privileged service on top of an operating system of an information handling system, the privileged service configured to:
configure a rules engine defining rules for selectively enabling and disabling an electronic privacy screen of a display device associated with the information handling system, the rules based on a configuration policy;
in response to an event for triggering enabling or disabling of the electronic privacy screen, determine a context of the information handling system;
based on the context and the rules engine, determine whether a threat level associated with the event is within a range for enabling the electronic privacy screen; and
based on the threat level, cause communication of a control signal to the display device, the control signal indicative of whether to enable or disable the electronic privacy screen.

16. The article of claim 15, wherein the event comprises one of an opening of an electronic document, a closing of an electronic document, and a change in an information protection setting of an electronic document.

17. The article of claim 15, wherein the context comprises one or more of a physical location of the information handling system, a device state of the information handling system, sensor data associated with the information handling system, and an application context of the information handling system.

18. The article of claim 15, wherein the display device is integrated with the information handling system in a common enclosure, and causing communication of the control signal to the display device comprises communication of the control signal through a communications interface coupled between the processor and a microcontroller unit of the display device.

19. The article of claim 15, wherein the display device is externally coupled to the information handling system via a cable, and causing communication of the control signal to the display device comprises communication of the control signal through a communications interface coupled between the information handling system and the display device.

20. The article of claim 15, wherein the display device is externally coupled to the information handling system via an intermediate device, and causing communication of the control signal to the display device comprises communication of the control signal from the information handling system to the intermediate device, and communication of the control signal from the intermediate device to the display device.

21. The article of claim 15, wherein causing communication of the control signal to the display device comprises communication of the control signal from a management controller of the information handling system.
